(19) United States
(12) Patent Application Publication
(10) Pub. No.: US 2012/0204980 A1
(43) Pub. Date: Aug. 16, 2012

(54) FUEL TANK SYSTEM AND FUEL SUPPLY SYSTEM

(75) Inventors: Kumiko Nishizawa, Susono-shi (JP); Toyokazu Baika, Susono-shi (JP)

(73) Assignee: TOYOTA JIDOSHA KABUSHIKI KAISHA, Toyota-shi (JP)

(21) Appl. No.: 13/503,688

(22) PCT Filed: Nov. 30, 2009
(86) PCT No.: PCT/JP2009/070436

§ 371 Date: Apr. 24, 2012

(51) Int. Cl. F17D 3/00

(52) U.S. Cl. 137/561 R

(57) ABSTRACT

A fuel tank system comprises a fuel tank which stores a water soluble fuel in a liquid state, detection devices which detect a temperature and pressure inside of the fuel tank, and a moisture content estimation device for estimating the moisture content in the fuel inside of the fuel tank based on the temperature and pressure which were detected by the detection devices. Due to this, it is possible to detect the moisture content or the amount of moisture in the fuel even when using a water soluble fuel.

### TECHNICAL FIELD

The present invention relates to a fuel tank system and to a fuel supply system which comprises a fuel tank system.

### BACKGROUND ART

In general, in a fuel tank which is used in an internal combustion engine or a fuel cell etc., the fuel itself which is supplied to the fuel tank sometimes will contain moisture or the moisture in the air which flows into the fuel tank will condense whereby water will be mixed into the fuel which is stored. The water which is mixed in the fuel may cause the fuel tank itself or the pipe for feeding fuel from the fuel tank to the fuel injection system to rust. Therefore, it becomes necessary to periodically drain the water from inside the fuel tank.

For this reason, a water draining system which drains the water from inside of a fuel tank when a certain extent of water has been mixed in a fuel tank has been proposed (for example, PLT 1). In the water draining system which is described in PLT 1, focusing attention on the fact that hydrophobic fuel and water separate in the fuel tank, the position of a float which is set in specific gravity so as to settle at the boundary between the fuel and water is used to detect the amount of water inside of the fuel tank, and, when the amount of water detected exceeds a certain amount, a water drain hole which is formed at the bottom of the fuel tank is opened to drain the water from inside of the fuel tank.

### CITATIONS LIST

### Patent Literature

PLT 1: Japanese Utility Model Publication (A) No. 1-176745
PLT 2: Japanese Patent Publication (A) No. 63-224707
PLT 3: Japanese Utility Model Publication (A) No. 2-004960
PLT 4: Japanese Utility Model Publication (A) No. 61-128133

### SUMMARY OF INVENTION

### Technical Problem

In this regard, when using a hydrophobic fuel like gasoline or diesel oil as fuel in the above-mentioned way, the fuel and water separate. Therefore, it is possible to detect only the amount of the separated water. However, when using an alcohol or another water soluble (hydrophilic) fuel as the fuel, the fuel and water will not separate and therefore the method of detection which uses a float of the above PLT 1 cannot be used to detect the amount of moisture or moisture content in the fuel.

Therefore, in consideration of the above problem, the purpose of the present invention is to provide a fuel tank system which enables the moisture content or amount of moisture in the fuel to be detected even when using a water soluble fuel.

### Solution to Problem

The present invention provides a control device of an internal combustion engine as set forth in the claims as means for solving this problem.

In a first aspect of the present invention, there is provided a fuel tank system comprising a fuel tank which stores a water soluble fuel in a liquid state, detection devices which detect temperature and pressure inside of the fuel tank, and a moisture content estimation device for estimating the moisture content in the fuel in the fuel tank based on the temperature and pressure which were detected by the detection devices.

According to this aspect, the moisture content in the fuel is estimated based on the temperature and pressure in the fuel tank, for example, utilizing the fact that the equilibrium vapor pressure differs between fuel and water. Due to this, even if using a water soluble fuel, it is possible to detect the moisture content or the amount of moisture in the fuel.

In a second aspect of the present invention, the fuel tank is provided with a replaceable desiccant, the desiccant is placed so that fuel which is supplied from a fuel filler of the fuel tank passes the desiccant before being stored inside of the fuel tank, and the fuel tank system is further provided with a warning device which issues a warning, which prompts replacement of the desiccant, based on the moisture content which was estimated by the moisture content estimation device.

In a third aspect of the present invention, the system further comprises a residual fuel detection device which detects a remaining amount of fuel which is stored inside the fuel tank, wherein the remaining amount of fuel which was detected by the residual fuel detection device is corrected based on the moisture content which was estimated by the moisture content estimation device.

In a fourth aspect of the present invention, the estimation of the moisture content by the moisture content estimation device is performed using a map or calculation formula expressing a relationship among the temperature inside the fuel tank, the pressure inside the fuel tank, and the moisture content in the fuel.

In a fifth aspect of the present invention, there is provided a fuel supply system comprising a fuel tank system according to any of the first to fourth aspects and a fuel feed device which is connected to the fuel tank of the fuel tank system and which feeds fuel which is fed from the fuel tank to a fuel feed destination in a liquid state in exactly a target feed amount of fuel, wherein the target feed amount of fuel is corrected based on the moisture content which was estimated by the content estimation device.

In a sixth aspect of the present invention, there is provided a fuel supply system comprising a fuel tank system according to any of the first to fourth aspects and a fuel feed device which is connected to the fuel tank of the fuel tank system and which feeds fuel which is fed from the fuel tank to a fuel feed destination in a gaseous state in exactly a target feed amount of fuel, wherein the moisture content in the fuel in the gaseous state is calculated based on the moisture content in the fuel in the liquid state which was estimated by the content estimation device, and the target feed amount of fuel is corrected based on the moisture content in the fuel in the gaseous state.

In a seventh aspect of the present invention, the fuel supply system is a fuel supply system of an internal combustion engine or a fuel supply system of a fuel cell.

Below, the present invention will be able to be understood much more clearly from the attached drawings and the description of the preferred embodiments of the present invention.

### BRIEF DESCRIPTION OF DRAWINGS

FIG. 1 is a schematic view of an internal combustion engine which mounts a fuel tank system and fuel supply system of the present invention.

FIG. 2 is a view which schematically shows a fuel tank system of a first embodiment.

FIG. 3 is a view which shows a relationship between temperature and pressure in a fuel tank when using ammonia as a fuel.

FIG. 4 is a view showing a relationship between molar fraction of ethanol and water, and a pressure inside a fuel tank.

FIG. 5 is a view which schematically shows a fuel tank system of a second embodiment.

FIG. 6 is a view which schematically shows a fuel tank system of a third embodiment.

### DESCRIPTION OF EMBODIMENTS

Below, embodiments of the present invention will be explained in detail while referring to the drawings. Note that, in the following explanation, similar component elements are assigned the same reference numerals.

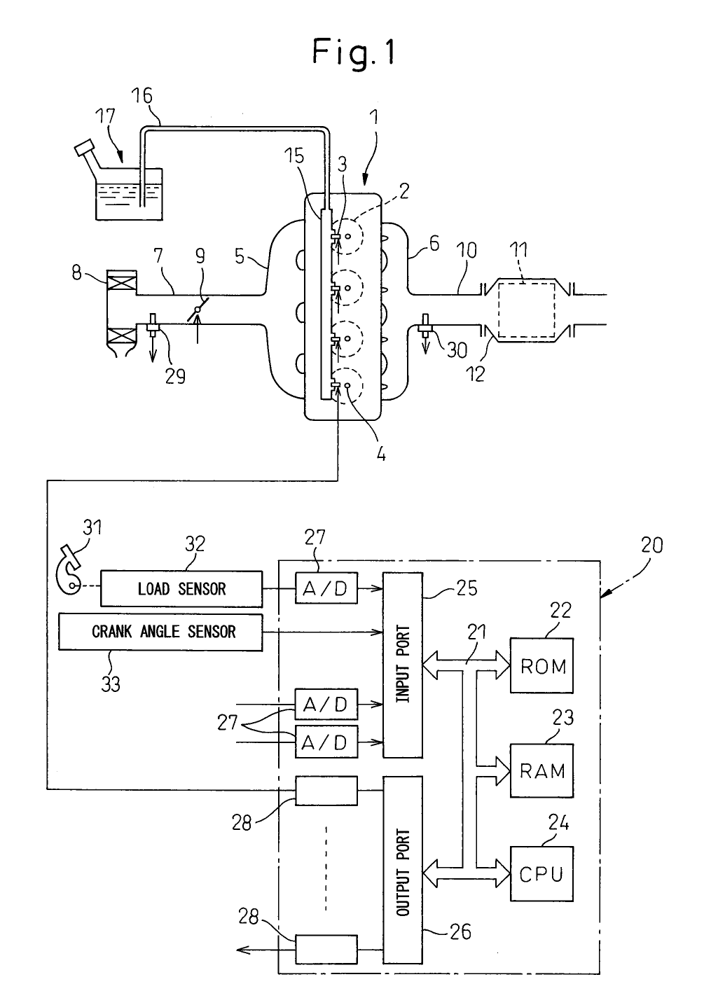

FIG. 1 is a schematic view showing an internal combustion engine mounting a fuel tank system and fuel supply system of the present invention. Referring to FIG. 1, 1 indicates an engine body, 2 a combustion chamber of each cylinder, 3 a fuel injector for injecting fuel into each combustion chamber 2, 4 a spark plug, 5 an intake manifold, and 6 an exhaust manifold. The intake manifold 5 is connected through an intake pipe 7 to an air cleaner 8. Inside the intake pipe 7, a throttle valve 9 which is driven by a step motor is arranged. On the other hand, the exhaust manifold 6 is connected through an exhaust pipe 10 to a casing 12 housing an exhaust purification catalyst (for example, three-way catalyst) 11. Each fuel injector 3 is connected to a fuel reservoir 15. This fuel reservoir 15 is connected through a fuel feed pipe 16 to a fuel tank system 17. Note that, in the present embodiment, the fuel injectors 3 are configured to directly inject fuel into the combustion chambers 2, but they may also be configured to inject fuel to intake ports communicated with the combustion chambers 2.

The electronic control unit (ECU) 20 is comprised of a digital computer and is provided with components which are connected to each other by a bidirectional bus 21 such as a ROM (read only memory) 22, RAM (random access memory) 23, CPU (microprocessor) 24, input port 25, and output port 26. The intake pipe 7 has an airflow meter 29 attached to it for detecting a flow rate of air which passes through the inside of the intake pipe 7. The output signal of the airflow meter 29 is input through a corresponding AD converter 27 to the input port 25. Further, at the exhaust pipe 10, an air-fuel ratio sensor 30 is attached for detecting the air-fuel ratio of the exhaust gas which passes through the inside of the exhaust pipe 10. The output signal of the air-fuel ratio sensor 30 is input through a corresponding AD converter 27 to the input port 25.

Further, an accelerator pedal 31 is connected to a load sensor 32 which generates an output voltage which is proportional to an amount of depression of the accelerator pedal 31. The output voltage of the load sensor 32 is input through a corresponding AD converter 27 to the input port 25. Further, the input port 25 has a crank angle sensor 23 connected to it which generates an output pulse every time a crank shaft rotates by for example 30°. This crank angle sensor 23 is used to detect the engine speed. On the other hand, the output port 26 is connected through corresponding drive circuits 28 to the fuel injectors 3 and the step motor for driving the throttle valve 9.

In the present internal combustion engine, as fuel, a water soluble fuel is used. Such a water soluble fuel includes a highly combustible or ignitable water soluble substance such as ethanol, methanol, or other alcohols, dimethyl ether, acetone or ammonia or mixtures of the same.

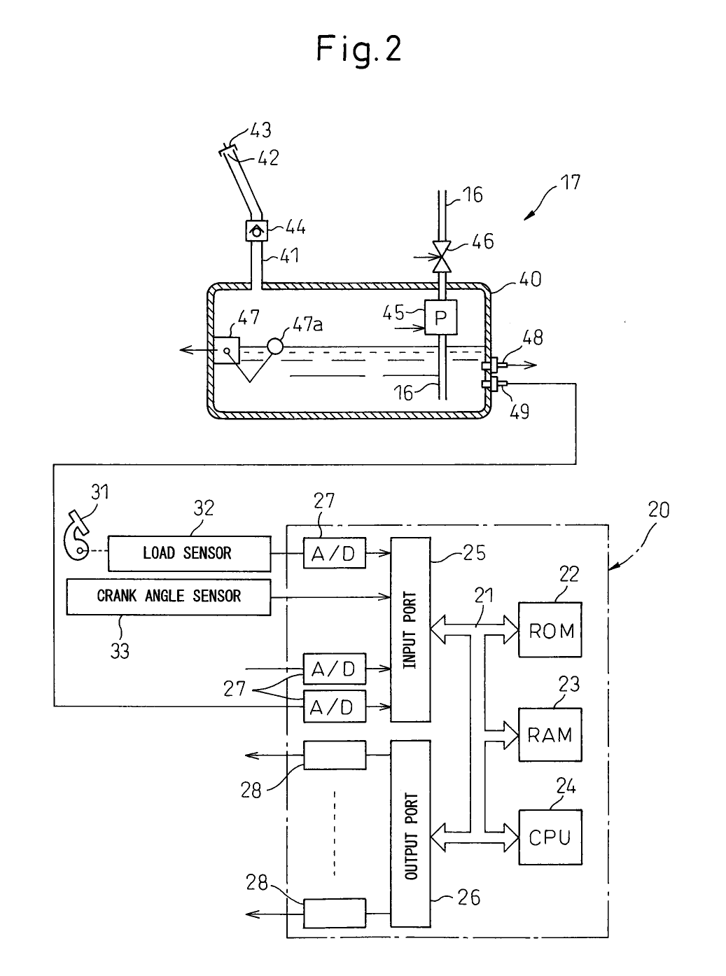

FIG. 2 is a view which schematically shows the fuel tank system 17 of the present invention. As shown in FIG. 2, the fuel tank system 17 comprises a fuel tank 40 which stores the fuel. The fuel tank 40 is connected to a fuel filling pipe 41. At the end of this fuel filling pipe 41, a fuel filler opening 42 is provided. At the fuel filler opening 42, a filler cap 43 is provided for closing the fuel filler opening 42. Further, at the fuel filling pipe 41, a check valve 44 is arranged between the fuel filler opening 42 and the fuel tank 40. The check valve 44 is configured to permit passage of liquid and gas from the fuel filler opening 42 to the inside of the fuel tank 40, but to prevent passage of liquid and gas from the inside of the fuel tank 40 to the fuel filler opening 42.

Further, the fuel tank 40 is connected to the fuel feed pipe 16. As shown in FIG. 2, the end of the fuel feed pipe 16 is arranged near the bottom of the fuel tank 40. The fuel feed pipe 16 is provided with a fuel pump 45 and shutoff valve 46 in the middle of it. The fuel pump 45 acts to send fuel which is stored inside the fuel tank 40 to the fuel feed pipe 16 and accordingly to the fuel reservoir 15 and fuel injectors 3. Further, the shutoff valve 46 shuts off the fuel feed pipe 16 so that fuel which is stored inside of the fuel tank 40 will not flow out from the fuel tank 40 in an emergency etc. These fuel pump 45 and shutoff valve 46 are connected through corresponding drive circuits 28 to the output port 26 of the ECU 20.

Furthermore, the fuel tank 40 is provided with a residual fuel gauge (residual fuel detection device) 47 which detects a remaining amount of fuel inside the fuel tank 40, a temperature sensor (temperature detection device) 48 which detects the temperature of the inside of the fuel tank 40, and a pressure sensor (pressure detection device) 49 which detects the pressure of the inside of the fuel tank. In the example which is shown in FIG. 1, the residual fuel gauge 47 is provided with a float 47a which floats on the fuel. It detects the position of the float 47a in the vertical direction and thereby detects the remaining amount of fuel which is stored inside of the fuel tank 40. Further, in the example which is shown in FIG. 2, the temperature sensor 48 and pressure sensor 49 are arranged at the side parts of the fuel tank 40, but alternatively they may be arranged at the bottom of the fuel tank 40 so as to detect the temperature and pressure of the liquid inside of the fuel tank 40 or may be arranged at the top of the fuel tank 40 so as to detect the temperature and pressure of the gas inside of the fuel tank 40. The output signals of the residual fuel gauge 47, temperature sensor 48, and pressure sensor 49 are respectively input through corresponding AD converters 27 to the input port 25.

In the thus configured fuel tank system 17, fuel is filled through the fuel filler opening 42 and fuel filling pipe 41 into the fuel tank 40. The fuel which was stored inside of the fuel tank 40 is sucked by the fuel pump 45 and supplied through the fuel feed pipe 16 to the fuel reservoir 15 and fuel injectors 3.

In this regard, in general, when supplying fuel from the fuel filler opening 42 to the inside of the fuel tank 40, sometimes water from the atmosphere is mixed into the fuel. Further, for example, when using ammonia or another fuel with a high affinity with water as a water soluble fuel, it is difficult to completely remove the water from the fuel at the stage of production of the fuel. Therefore, the produced fuel will contain a slight amount of water. Due to these reasons, in general, the fuel which is supplied from the fuel filler opening 42 contains a small amount of water. As a result, the fuel which is stored inside of the fuel tank 40 also contains a small amount of water.

If the fuel contains water in this way, a drop in output of the internal combustion engine or deterioration of the emissions will be invited. That is, if the fuel which is fed to the inside of the combustion chambers 2 of an internal combustion engine contains water, the true amount of fuel which is fed to the inside of the combustion chambers (the total amount of liquid which is fed to the combustion chambers 2 minus the amount of water) will become smaller by the amount of the water and, as a result, the output of the internal combustion engine will fall. Further, in general, in an internal combustion engine, the air-fuel ratio of the air-fuel mixture is controlled to the target air-fuel ratio set in accordance with the engine operating state so as to enable optimal purification of the exhaust gas. However, if the true amount of fuel which is fed to the combustion chambers 2 becomes smaller due to the water, the air-fuel ratio of the air-fuel mixture will deviate from the target air-fuel ratio and, as a result, deterioration of the exhaust emissions will be invited.

In this regard, such a drop in output of the internal combustion engine or deterioration of the exhaust emissions is due to the fact that the moisture content in the fuel which is fed to the inside of the combustion chambers 2 is unclear. Conversely, if it were possible to accurately grasp the moisture content in the fuel which is fed to the inside of the combustion chambers 2, it would be possible to grasp the true amount of fuel which is fed to the inside of the combustion chambers 2 and as a result would be possible to suppress a drop in output of the internal combustion engine or deterioration of the exhaust emissions.

Here, a conventional fuel tank system detects the moisture content in the fuel in the fuel tank (or the amount of water in the fuel tank) assuming use of a hydrophobic fuel as fuel (for example, said PLT 1 or PLT 4). In other words, a conventional fuel tank system detects only the amount of separated water by some sort of method assuming the fuel separates from the water.

However, when using a water soluble fuel as the fuel like in the present embodiment, the fuel and water do not separate in the fuel tank. For this reason, with the above-mentioned method of detection of only the amount of separated water, it is not possible to detect the moisture content or amount of water in the fuel inside of the fuel tank. Therefore, in the present embodiment, the moisture content in the fuel which is stored inside of the fuel tank is estimated based on the temperature and pressure inside of the fuel tank.

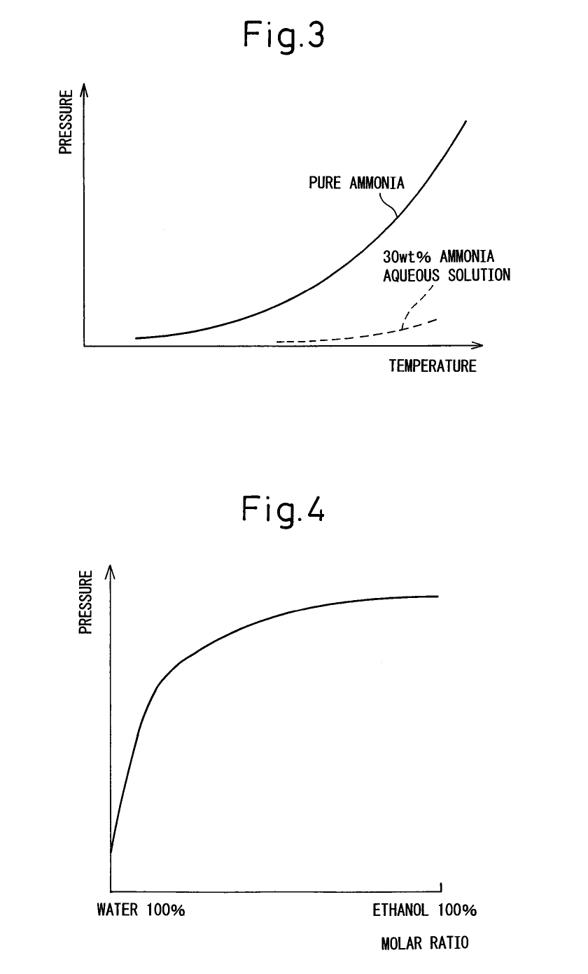

FIG. 3 is a view showing the relationship between the temperature and pressure inside of the fuel tank 40 in the case of using ammonia as the water soluble fuel. The solid line in the figure shows the relationship of temperature and pressure in pure ammonia with a concentration of ammonia of 100 wt %, while the broken line in the figure shows the relationship of temperature and pressure in ammonia with a concentration of ammonia water of 30 wt %.

As shown in FIG. 3, both in the case where the fuel tank 40 stores pure ammonia with a concentration of ammonia of 100 wt % (solid line in the figure) and in the case where the fuel tank 40 stores ammonia water with a concentration of ammonia of 30 wt % (broken line in the figure), the pressure inside of the fuel tank 40 becomes higher as the temperature inside of the fuel tank 40 becomes higher. However, regardless of the temperature inside of the fuel tank 40, the pressure is always higher in the case where the fuel tank 40 stores pure ammonia than the case where the fuel tank 40 stores ammonia water with a concentration of ammonia of 30 wt %. This is due to the fact that the equilibrium vapor pressure of ammonia is higher than the equilibrium vapor pressure of water.

Further, FIG. 4 is a view of the relationship between molar fraction of ethanol and water and the pressure inside of the fuel tank 40 when using ethanol as the water soluble fuel and making the temperature of the inside of the fuel tank 40 constant. As will be understood from FIG. 4, the lower the molar fraction of water, that is, the higher molar fraction of ethanol, the higher the pressure inside of the fuel tank 40. This is also due to the fact that the equilibrium vapor pressure of ethanol is higher than the equilibrium vapor pressure of water.

The water soluble substance which is used as fuel in the present embodiment has a higher equilibrium vapor pressure than the equilibrium vapor pressure of water. For this reason, in the water soluble fuel as a whole which is used in the present embodiment, a trend such as shown in FIG. 3 and FIG. 4 is recognized. That is, the relationship between the temperature and pressure inside of the fuel tank 40 changes in accordance with moisture content in the water soluble fuel. In particular, if the temperature inside of the fuel tank 40 is constant, the higher the moisture content in the water soluble fuel, the lower the pressure inside of the fuel tank 40.

Since the relationship between the temperature and pressure inside of the fuel tank 40 changes in accordance with moisture content in the water soluble fuel in this way, the moisture content in the fuel which is stored inside of the fuel tank 40 can be estimated based on the outputs of the temperature sensor 48 and pressure sensor 49 which detect the temperature and pressure inside of the fuel tank 40.

Specifically, in the present embodiment, a map is prepared in advance showing the relationship between the mixed ratio of fuel and water and the pressure inside of the fuel tank 40 such as shown in FIG. 4 for each temperature, that is, a map is prepared showing the relationship between the moisture content in the fuel, the temperature inside of the fuel tank 40, and the pressure inside of the fuel tank 40. Further, the map is used to calculate the moisture content in the fuel based on the output values of the temperature sensor 48 and pressure sensor 49. Note that, instead of a map, it is also possible to find in advance a calculation formula showing the relationship between the moisture content in the fuel, the temperature inside of the fuel tank 40, and the pressure inside of the fuel tank 40 and to use this calculation formula to calculate the moisture content in the fuel based on the output values of the sensors 48 and 49.

According to the present embodiment, by estimating the moisture content in the fuel which is stored inside of the fuel tank 40 based on the temperature and pressure inside of the fuel tank 40 in this way, it is possible to accurately estimate the moisture content even in the case of using a water soluble fuel.

Further, in the present embodiment, the amount of fuel injected from the fuel injectors 3 to the combustion chambers 2 is corrected, based on the moisture content in the fuel which was estimated in this way. Below, the method of correction of the amount of fuel injection will be explained.

In the fuel supply system of the present embodiment comprised of the fuel injectors 3, fuel reservoir 15, fuel feed pipe 16, and fuel tank system 17, for example, the intake air amount Mc which is calculated from the output value of the airflow meter 29 is used as the basis to calculate the target fuel injection amount (target fuel feed amount) TAUt from the fuel injectors 3 so that the air-fuel ratio becomes the target air-fuel ratio (for example, the stoichiometric air-fuel ratio).

Next, in the present embodiment, the estimated moisture content in the fuel Rwt is used as the basis to calculate the corrected target fuel injection amount TAUtm by the following formula (1) so that the true amount of fuel which is injected from the fuel injectors 3 becomes equal to the target fuel injection amount, and the fuel injectors 3 are controlled so that fuel of the calculated corrected target fuel injection amount TAUtm (fuel containing water) is injected.

TAUtm=TAUt·10000/(100−Rwt) (1)

By correcting the amount of fuel which is injected from the fuel injectors 3 in this way, it is possible to make the true amount of fuel which is injected into the combustion chambers 2 (total amount of liquid which is supplied to combustion chambers 2 minus amount of water) match the target fuel injection amount which was calculated based on the engine operating state. Due to this, it is possible to suppress a drop in output of the internal combustion engine or deterioration of exhaust emissions.

Note that, in the above embodiment, the target fuel injection amount is calculated based on the intake air amount Mc. However, the target fuel injection amount may be calculated by another method different from the above embodiment, for example based on the engine load which is detected by the load sensor 32, the engine speed which is detected by the crank angle sensor 33, etc.

Further, in the above embodiment, the example of application of the fuel tank system 17 and fuel supply system of the present invention to an internal combustion engine is shown. However, the above explained fuel tank system 17 and fuel supply system may also be applied to mechanisms requiring such a fuel tank system and fuel supply system other than an internal combustion engine, for example, a fuel cell etc. Therefore, if expressing these all together, it can be said that the fuel supply system of the present embodiment is configured to feed the fuel which was supplied from the fuel tank to the fuel feed destination (in the case of an internal combustion engine, the combustion chambers 2 or the intake port) in the liquid state in exactly the target feed amount of fuel and to correct the target feed amount of fuel based on the moisture content.

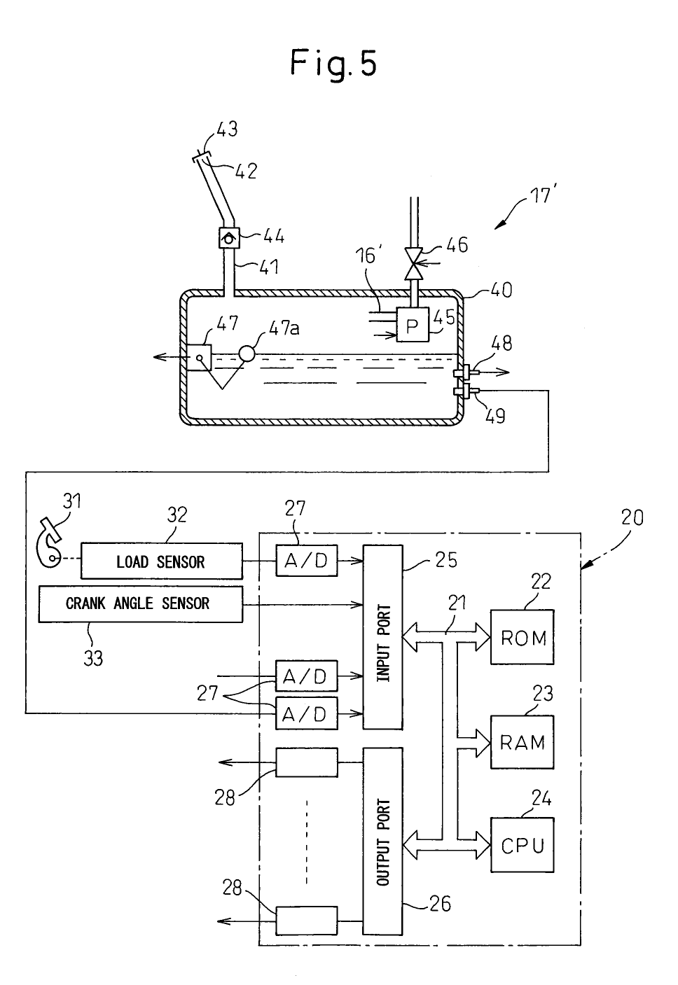

Next, referring to FIG. 5, a fuel tank system and fuel supply system of a second embodiment of the present invention will be explained. As will be understood from FIG. 5, the configurations of the fuel tank system and fuel supply system of the second embodiment are basically similar to the configurations of the fuel tank system and fuel supply system of the first embodiment.

However, in the first embodiment, the end of the fuel feed pipe 16 is arranged near the bottom of the fuel tank 40, while in the present embodiment, the end of the fuel feed pipe 16′ is arranged near the top of the fuel tank 40. Therefore, in the first embodiment, the fuel feed pipe 16 sucks in liquid fuel which is stored at the bottom of the fuel tank 40 and therefore the fuel injectors 3 are fed with liquid fuel, while in the present embodiment, the fuel feed pipe 16′ sucks in gaseous fuel which is present near the top of the fuel tank 40 and therefore the fuel injectors 3 are fed with gaseous fuel.

In this regard, the equilibrium vapor pressure of water soluble fuel is higher than the equilibrium vapor pressure of water, and therefore fuel vaporizes easier than water. For this reason, in a fuel tank system 17′ configured such as shown in FIG. 5, as the period of use becomes longer, moisture remains and builds up inside the fuel tank 40 and the moisture content or the amount of moisture in the fuel which is stored gradually increases. If the amount of moisture in the fuel increases in this way, even when the fuel tank 40 only stores a small amount of the true fuel, the residual fuel gauge 47 will detect a certain amount of fuel, and therefore error will occur in the remaining amount of fuel which is detected by the residual fuel gauge 47.

Further, in the thus configured fuel tank system 17′ as well, if the liquid fuel which is stored inside of the fuel tank 40 contains moisture, the gaseous fuel inside of the fuel tank 40 will also contain moisture. Therefore, in this case as well, for similar reasons to the above-mentioned reasons, a drop in output of the internal combustion engine and deterioration in the exhaust emissions will be invited.

Therefore, in the present embodiment as well, in the same way as the first embodiment, the moisture content in the liquid fuel which is stored inside of the fuel tank 40 is estimated based on the temperature and pressure inside of the fuel tank 40, and based on the moisture content in the liquid fuel, the true remaining amount of fuel is estimated and the target fuel injection amount is corrected.

First, the estimation of the true remaining amount of fuel will be explained. As explained above, the remaining amount of fuel which is detected by the residual fuel gauge 47 contains an amount of water. In other words, the remaining amount of fuel which is detected by the residual fuel gauge 47 becomes the true amount of fuel which is stored inside of the fuel tank 40 plus the amount of water. Therefore, in the present embodiment, the remaining amount of fuel FR which was detected by the residual fuel gauge 47 is corrected based on the moisture content in the liquid fuel Rwt, which is estimated by a similar method to the first embodiment, by the following formula (2) so as to calculate the corrected remaining amount of fuel FRm.

FRm=FR·(100−Rwt) (2)

The thus calculated corrected remaining amount of fuel FRm shows the true amount of fuel which is stored in the fuel tank 40 (total amount of liquid which is stored in the fuel tank 40 minus amount of water). Due to this, it is possible to accurately grasp the true amount of fuel inside of the fuel tank 40.

Next, the correction of the target fuel injection amount based on the moisture content in the liquid fuel will be explained. As explained above, the moisture content in the liquid fuel can be estimated based on the temperature and pressure inside of the fuel tank 40, but the moisture content in the liquid fuel and the moisture content in the gaseous fuel are not always the same. Therefore, in the present embodiment, the moisture content in the gaseous fuel is calculated based on the moisture content in the liquid fuel.

Here, if the activity coefficient of fuel is γ_{fuel}, the molar fraction of the liquid phase fuel is x_{fuel}, the equilibrium vapor pressure of the fuel pure substance is P_{fuel}, the activity coefficient of water is γ_{H2O}, the molar fraction of the liquid phase water is x_{H2O}, and the equilibrium vapor pressure of the water pure substance is P_{H2O}, if considering the gas-liquid equilibrium inside of the fuel tank 40, the following formulas (3) and (4) stand. Note that, in the following formulas (3) and (4), p_{fuel} shows the partial pressure of the gas phase fuel, while p_{H2O} shows the partial pressure of the gas phase water.

p_{fuel}γ_{fuel}·x_{fuel}·P_{fuel} (3)

p_{H2O}γ_{H2O}·x_{H2O}·P_{H2O} (4)

The equilibrium vapor pressure P_{fuel} of the fuel pure substance and the equilibrium vapor pressure P_{H2O} of the water pure substance are determined by the temperature inside of the fuel tank 40. Further, the activity coefficient γ_{fuel} of the fuel is determined by liquid phase fuel molar fraction x_{fuel}, while the activity coefficient γ_{H2O} of water is determined by the liquid phase water molar fraction x_{H2O}. For this reason, the partial pressure p_{fuel} of the gas phase fuel and the partial pressure p_{H2O} of the gas phase water can be calculated based on the liquid phase fuel molar fraction x_{fuel}, water molar fraction x_{H2O}, and temperature inside of the fuel tank 40.

Here, the molar fraction of the liquid phase fuel and water can be calculated by the above-mentioned moisture content in the fuel. Further, the temperature inside of the fuel tank 40 can be detected by the temperature sensor 48. For this reason, in the present embodiment, the partial pressure p_{fuel} of the gas phase fuel and the partial pressure p_{H2O} of the gas phase water can be calculated using the above formulas (3) and (4). Due to this, it is possible to calculate the moisture content in the fuel in the gas phase Rwtgas.

Further, in the present embodiment. The amount of fuel injection from the fuel injectors 3 to the insides of the combustion chambers 2 is corrected based on the thus estimated moisture content in the gaseous fuel Rwtgas in the same way as the first embodiment. That is, in the present embodiment, based on the moisture content in the gaseous fuel Rwtgas, the corrected target fuel injection amount TAUtm is calculated by the above formula (1) so that the true amount of fuel which is injected from the fuel injectors 3 becomes equal to the target fuel injection amount. The fuel injectors 3 are controlled so that the calculated corrected target fuel injection amount TAUtm of fuel (fuel containing water) is injected.

Note that, in the first embodiment, the remaining amount of fuel is not corrected based on the moisture content in the liquid phase fuel. However, even in the case of the first embodiment, error occurs in the remaining amount of fuel which is detected by the residual fuel gauge 47, and therefore in the same way as the second embodiment, it is also possible to correct the remaining amount of fuel based on the moisture content in the liquid phase fuel.

Further, for the present embodiment as well, it is also possible to apply the fuel tank system 17′ and fuel supply system explained above to a mechanism other than an internal combustion engine, for example, a fuel cell etc. Therefore, expressing these all together, the fuel supply system of the present embodiment can be said to be configured to feed the fuel which was fed from the fuel tank to the fuel feed destination (in the case of an internal combustion engine, the combustion chambers 2 or the intake port) in the gaseous state in exactly the target feed amount of fuel, to calculate the moisture content in the fuel in the gaseous state based on the moisture content in the fuel in the liquid state, and to correct the target feed amount of fuel based on the moisture content in the fuel in the gaseous state.

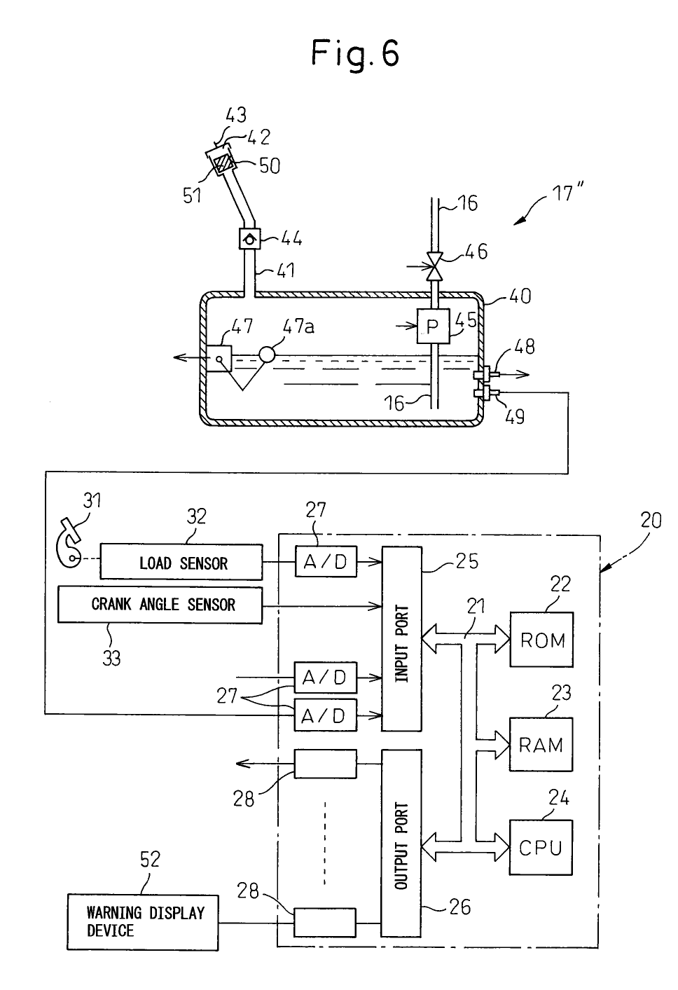

Next, referring to FIG. 6, a fuel tank system of a third embodiment of the present invention will be explained. As will be understood from FIG. 6, the configuration of the fuel tank system of the third embodiment is basically similar to the fuel tank system of the first embodiment.

However, as will be understood from FIG. 6, in the fuel tank system 17″ of the present embodiment, near the fuel filler opening 42, the fuel filling pipe 41 is provided with a desiccant mounting part 50. The desiccant mounting part 50 has a cartridge type desiccant (water absorbing material) 51 attached to this. The cartridge type desiccant 51 is designed to absorb the moisture in the fuel which runs through the inside of the desiccant 51 and is replaceable. As the desiccant 51, desiccant which physically adsorbs water, for example, a molecular sieve or silica gel, or basic desiccant which chemically adsorbs water, for example, quicklime, may be used. Note that, in the present embodiment, the desiccant 51 is arranged near the fuel filler opening 42 inside of the fuel filling pipe 41, but it may be arranged at any position so long as the fuel which is supplied from the fuel filler opening 42 passes through the desiccant 51 before being stored in the fuel tank 40. Further, in the present embodiment, the warning display device 52 is connected to the drive circuit 28 of the ECU 20.

In the thus configured fuel tank system 17″, when filling the inside of the fuel tank 40 with fuel, the fuel will always pass through the desiccant 51. For this reason, even if the fuel which is supplied to the fuel filler opening 42 contains moisture, that moisture is removed by the desiccant 51, and therefore basically the moisture content of the fuel which is stored inside the fuel tank 40 is maintained low.

In this regard, the moisture absorbing ability by the desiccant 51 is not always constant, but falls along with the increase in the amount of absorption of moisture by the desiccant 51. For this reason, if using the desiccant 51 for a long period, it no longer becomes possible to sufficiently remove the moisture in the fuel which is supplied to the fuel filler opening 42 by the desiccant 51 and, as a result, the moisture content of the fuel which is stored inside the fuel tank 40 increases.

Therefore, in the present embodiment, in the same way as the first embodiment, the moisture content in the fuel which was stored in the fuel tank 40 is estimated by the temperature and pressure inside of the fuel tank 40 which were detected by the temperature sensor 48 and pressure sensor 49, and a warning is issued by the warning display device 52 which prompts the replacement of the desiccant 51 when the estimated moisture content becomes a predetermined limit content or more.

Due to this, if the moisture absorbing ability by the desiccant 51 falls, a warning is issued on the warning display device 52, and therefore the moisture absorbing ability of the desiccant 51 can constantly be maintained a certain extent or more.

Note that, in the present embodiment as well, in the same way as the first embodiment and second embodiment, the target fuel injection amount may be corrected based on the moisture content of the fuel. Further, for the present embodiment as well, the above-mentioned fuel tank system 17″ may be applied to a mechanism other than an internal combustion engine such as a fuel cell etc.

Note that, the present invention is explained in detail based on specific embodiments, but a person skilled in the art could make various changes, revisions, etc. without departing from the claims and concept of the present invention.

### REFERENCE SIGNS LIST

20 electronic control unit (ECU)
40 fuel tank
41 fuel filling pipe
42 fuel filler opening
44 check valve
45 fuel pump
46 shutoff valve
47 residual fuel gauge
48 temperature sensor
49 pressure sensor

1. A fuel tank system comprising a fuel tank which stores a water soluble fuel in a liquid state, detection devices which detect temperature and pressure inside of said fuel tank, and a moisture content estimation device for estimating the moisture content in the fuel in the fuel tank based on the temperature and pressure which were detected by the detection devices.

2. A fuel tank system as set forth in claim 1, wherein
said fuel tank is provided with a replaceable desiccant, the desiccant being placed so that fuel which is supplied from a fuel filler opening of the fuel tank passes the desiccant before being stored inside of the fuel tank, and
said fuel tank system is further provided with a warning device which issues a warning, which prompts replacement of the desiccant, based on the moisture content which was estimated by said moisture content estimation device.

3. A fuel tank system as set forth in claim 1, further comprising a residual fuel detection device which detects a remaining amount of fuel which is stored inside said fuel tank,
wherein the remaining amount of fuel which was detected by said residual fuel detection device is corrected based on the moisture content which was estimated by said moisture content estimation device.

4. A fuel tank system as set forth in claim 1, wherein the estimation of the moisture content by said moisture content estimation device is performed using a map or calculation formula expressing a relationship among the temperature inside the fuel tank, the pressure inside the fuel tank, and the moisture content in the fuel.

5. A fuel supply system comprising a fuel tank system according to claim 1, and a fuel feed device which is connected to the fuel tank of the fuel tank system and which feeds fuel which is fed from said fuel tank to a fuel feed destination in a liquid state in exactly a target feed amount of fuel,
wherein said target feed amount of fuel is corrected based on the moisture content which was estimated by said content estimation device.

6. A fuel supply system comprising a fuel tank system according to claim 1, and a fuel feed device which is connected to the fuel tank of the fuel tank system and which feeds fuel which is fed from said fuel tank to a fuel feed destination in a gaseous state in exactly a target feed amount of fuel,
wherein the moisture content in the fuel in the gaseous state is calculated based on the moisture content in the fuel in the liquid state which was estimated by said content estimation device, and said target feed amount of fuel is corrected based on the moisture content in the fuel in the gaseous state.

7. A fuel supply system as set forth in claim 5 wherein the fuel supply system is a fuel supply system of an internal combustion engine or a fuel supply system of a fuel cell.
